(19) United States
(12) Patent Application Publication
(10) Pub. No.: US 2007/0083751 A1
(43) Pub. Date: Apr. 12, 2007

(54) System and method for certificate based document processing

(75) Inventors: Sameer Yami, Irvine, CA (US); Amir Shahindoust, Laguna Niguel, CA (US); Michael Yeung, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/447,465

(22) Filed: Jun. 6, 2006

Related U.S. Application Data
(60) Provisional application No. 60/724,700, filed on Oct. 7, 2005.

(51) Int. Cl. H04L 9/00

(52) U.S. Cl. 713/156

(57) ABSTRACT

A system and method for certificate-based document processing authority is provided. Upon receipt of a request for access for document processing operations, an administrator selects a set of allowable functions corresponding to the requesting user. A document processing device is then designated for performing any requested operations and a certificate is generated by the administrator. The certificate is then sent to the designated document processing device, which functions as a certificate authority, for signing. Once signed, the certificate is issued to the requesting user. When a document processing request is received by the document processing device, a comparison is made between the requested operation and the set of allowable functions contained in the certificate associated with the user sending the request. The operation is then selectively performed based upon the results of the comparison.

### CROSS-REFERENCE TO RELATED APPLICATIONS

This application claims priority to U.S. Provisional Patent Application No. 60/724,700, titled SYSTEM AND METHOD FOR HANDLING OF CERTIFICATE EXCHANGE FOR DEVICE PROFILE WEB SERVICES, filed on Oct. 7, 2005.

### BACKGROUND OF THE INVENTION

The subject application is directed to a system and method for certificate-based document processing. More particularly, the subject application is directed to a system and method for accessing data services and issuing client certificates by a document processing device.

Typically, professionals routinely work with documents or other data while away from their office environment. These professionals need to generate image data, by printing or scanning a document, and then need to distribute or perform other functions on such image data. Multifunctional peripheral devices, such as printers and scanning devices, routinely perform such operations. The multifunctional peripheral will typically provide such services based on access rights granted to the user or payments provided by the user. The multifunctional peripheral device will need to store or have access to information about the rights granted to the user or payments made by the user. When a user accesses such device, the exchange of trust certificates, governing the relationship between the user and the device is difficult. Generally, the device is limited in capabilities with respect to secure certificate exchange, and when such exchange is enabled, the certificates are limited to time-based restrictions only. As such, there is a need for a system and method for accessing data services and issuing client certificates by a document processing device.

The subject application overcomes the above mentioned problems and provides a system and method for certificate-based document processing.

### SUMMARY OF THE INVENTION

In accordance with the subject application, there is provided a system and method for certificate-based document processing.

Further, in accordance with the subject application, there is provided a system and method for accessing data services.

Still further, in accordance with the subject application, there is provided a system and method for issuing client certificates by a document processing device.

Still further, in accordance with the subject application, there is provided a system for certificate-based document processing. The system includes receiving means adapted for receiving a certificate request from an associated user, which certificate request includes identification data representative of an identification of the associated user. The system also includes generator means adapted for generating a certificate in accordance with the received certificate request. The certificate includes constraint data representative of a set of allowable functions for the associated user for at least one associated document processing device. The system also comprises output means adapted for communicating the certificate to a storage associated with the at least one associated document processing device and means adapted for receiving a document processing request from the associated user for the at least one associated document processing device. The document processing request includes data corresponding to the certificate, the document processing request further including job request data representative of at least one desired document processing operation. The system further comprises verification means adapted for comparing a received document processing request with the certificate to determine whether the at least one desired document processing operation corresponds to the set of allowable functions and means adapted for communicating data representative of the certificate to the associated user. The system further includes means adapted for selectively commencing a document processing operation on the at least one associated document processing device in accordance with an output of the verification means and means adapted for generating a notice to the associated user regarding a commenced document processing operation.

Still further, in accordance with the subject application, there is provided a method for certificate-based document processing. The method comprises the steps of receiving a certificate request from an associated user, wherein the certificate request includes identification data representative of an identification of the associated user. A certificate is generated in accordance with a received certificate request, which certificate includes constraint data representative of a set of allowable functions for the associated user for at least one associated document processing device, and the certificate is communicated to a storage associated with the at least one associated document processing device and is communicated to the associated user. A document processing request is received from the associated user for the at least one associated document processing device, wherein the document processing request includes data corresponding to the certificate, the document processing request further including job request data representative of at least one desired document processing operation. The received document processing request is compared with the certificate to determine whether the at least one desired document processing operation corresponds to the set of allowable functions. A document processing operation on the at least one associated document processing device is commenced in accordance with an output of the comparing a received document processing request with the certificate and a notice to the associated user is generated regarding the commenced document processing operation.

In one embodiment, the set of allowable functions includes at least one of maximum number of pages, maximum number of jobs, color output, media, paper type, storage, and finishing options.

In another embodiment, the certificate request includes payment data, and wherein the system and method have the ability to generate the constraint data in accordance with payment data. More preferably, the certificate includes address data corresponding to a network address of the at least one associated document processing device.

In a further embodiment, the receipt of the certification, the generation of the certificate, and the communication of the certificate to storage is performed via an administrator in data communication with the associated user via an associated network.

In yet another embodiment, the network address includes a URL of the associated document processing device, and wherein the associated document processing device includes a multi-function peripheral.

Still other advantages, aspects and features of the subject application will become readily apparent to those skilled in the art from the following description wherein there is shown and described a preferred embodiment of the subject application, simply by way of illustration of one of the best modes best suited for to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 which is an overall system diagram of the system for certificate-based document processing according to the subject application;

FIG. 2 is a block diagram illustrating controller hardware for use in the system for certificate-based document processing according to the subject application;

FIG. 3 is a functional block diagram illustrating the controller for use in the system for certificate-based document processing according to the subject application;

FIG. 4 is a block diagram illustrating workstation hardware for use in the system for certificate-based document processing according to the subject application;

FIG. 5 is a flowchart illustrating the method for certificate-based document processing for the certificate generation side according to the subject application; and

FIG. 6 is a flowchart illustrating the method for certificate-based document processing from the certificate usage side according to the subject application.

### DETAILED DESCRIPTION OF THE PREFERRED EMBODIMENT

The subject application is directed a system and method for certificate-based document processing. In particular, the subject application is directed to a system and method for accessing data services. More particularly, the subject application is directed to a system and method for issuing and using client certificates by a document processing device. As will be appreciated by those of ordinary skill in the art, the subject application is directed to a system and method for generating and using certificates so as to enable secure document processing operations on a document processing device.

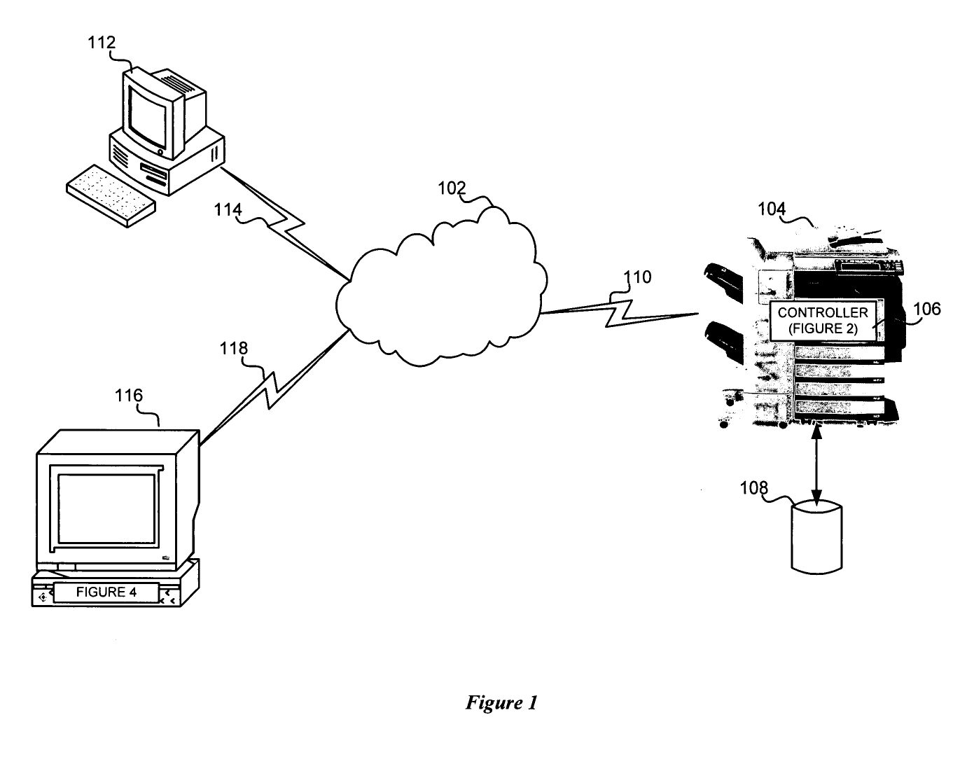

Referring now to FIG. 1, there is shown a diagram illustrating an overall system 100 for certificate-based document processing in accordance with the subject application. The system 100 includes a distributed computing environment, represented in FIG. 1 as a computer network 102. It will be appreciated by those skilled in the art that the computer network 102 is any distributed communications environment known in the art capable of allowing two or more electronic devices to exchanged data. The skilled artisan will understand that the computer network 102 is any computer network, known in the art, including for example and without limitation, a personal area network, a local area network, a virtual network, a wide area network, an intranet, the Internet, or any suitable combination thereof. In the preferred embodiment of the subject application, the computer network 102 is comprised of physical layers and transport layers, as illustrated by the myriad of conventional data transport mechanisms, both secured and open, such as, for example and without limitation, Ethernet, 802.11(x), Token-Ring, or other wired or wireless data communication mechanisms. Preferably, the computer network 102 is capable of employing one or more security protocols to provide secure data communications between electronic devices communicatively coupled thereto.

As shown in FIG. 1, the system 100 also includes a document processing device 104, represented as a multifunction peripheral device. It will be understood by those skilled in the art that the document processing device 104 is suitably adapted to provide a variety of document processing services, such as, for example and without limitation, electronic mail, scanning, copying, facsimile, document management, printing, and the like. In one embodiment of the subject application, the document processing device 104 further includes hardware, software, or any combination thereof, suitably adapted to function as a certificate authority. Suitable commercially available document processing devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the subject application, the document processing device 104 further includes an associated user-interface, such as a touch-screen interface, LCD display, or the like, via which an associated user is able to interact directly with the document processing device 104. Preferably, the document processing device 104 further includes a data storage device 108, communicatively coupled to the document processing device 104, suitably adapted to provide data storage, in accordance with the functioning of the document processing device 104 as a certificate authority. More preferably, the data storage device 108 is capable of functioning as a constraint data storage, as will be explained in greater detail below. As will be understood by those skilled in the art, the data storage device 108 is any mass storage device known in the art including, for example and without limitation, a hard disk drive, other magnetic storage devices, optical storage devices, flash memory devices, or any combination thereof.

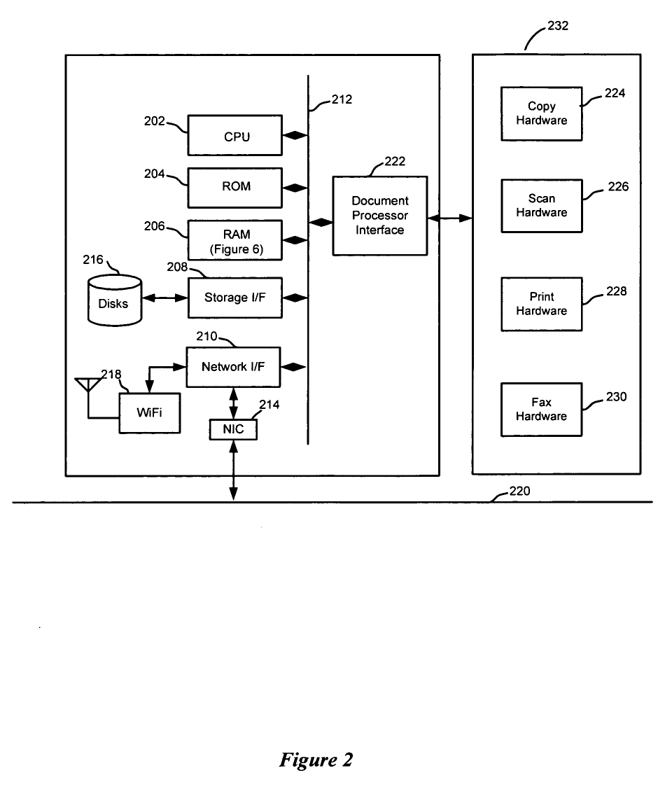

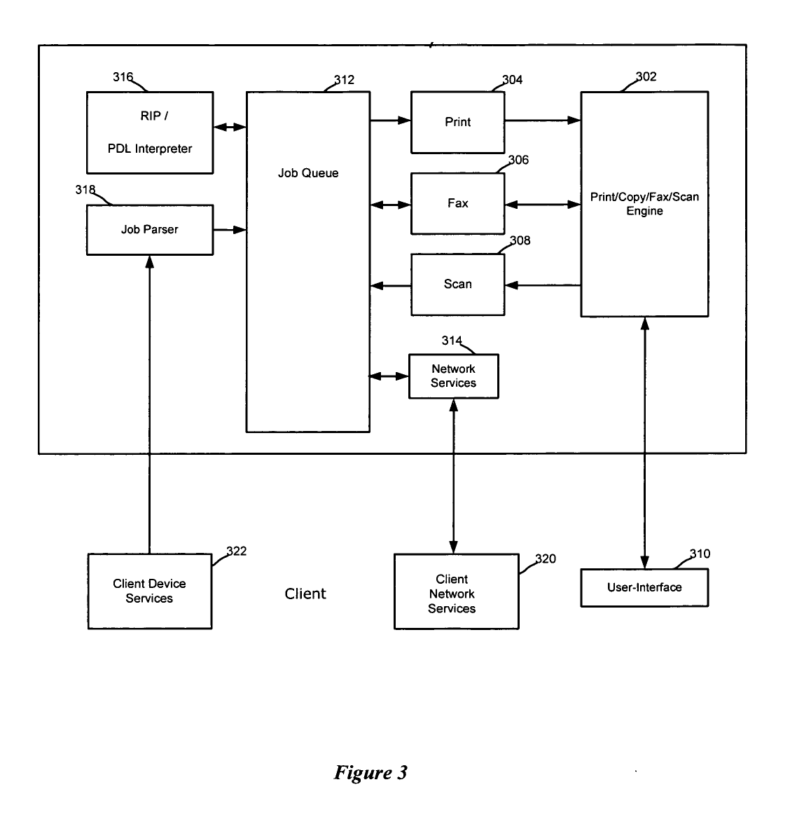

Preferably, the document processing device 104 further incorporates a controller 106, suitably adapted to facilitate the operations of the first document processing device 104, as will be understood by those skilled in the art. Preferably, the controller 106 is embodied as hardware, software, or any suitable combination thereof, configured to control the operations of the associated document processing device 104, control the display of images via the associated user-interface, validate user information, verify certificates, facilitate communications with external devices, and the like. While the controller 106 is depicted in FIG. 1 as being an integrated component of the document processing device 104, the skilled artisan will appreciate that the controller 106 is suitably capable of being implemented as an external device, communicatively coupled to the document processing device 104. The functioning of the controller 106 will better be understood in conjunction with the block diagrams illustrated in FIGS. 2 and 3, explained in greater detail below.

In accordance with the preferred embodiment of the subject application, the document processing device 104 is in data communication with the computer network 102 via a suitable communications link 110. As will be appreciated by the skilled artisan, a suitable communications links 110 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art. The skilled artisan will further appreciate that the communications link 110 is capable of employing any of a plurality of security protocols for secure data communications, as are known in the art.

The system 100, as illustrated in FIG. 1, further includes an administrator device 112. It will be understood by those skilled in the art that the use of the device 112 is representative of any system or network administrator, suitably capable of providing user access rights to the use of the document processing device 104. Preferably, the administrator device 112 is capable of facilitating the generation of certificates for use by the document processing device 104 and an associated user, whereby document processing operations are performed. The skilled artisan will appreciate the administrator device 112 is suitably adapted to function in an administrative role on the computer network 102, controlling the rights and access privileges of other devices and users coupled thereto. The administrator device 112 is communicatively coupled to the computer network 102 via a communications link 114. The communications link 114 is any suitable communications channel known in the art enabling the two-way communication of data including, for example and without limitation, 802.11a, 802.11b, 802.11g, 802.11(x), Bluetooth, WiMax, a proprietary communications channel, infrared, optical, the public switched telephone network, or any other suitable wire-based or wireless data transmission communications known in the art. In accordance with the preferred embodiment of the subject application, the communications link 114 is capable of employing a variety of transport security protocols, as are known in the art.

The system 100 illustrated in FIG. 1 further includes at least one user device, illustrated in FIG. 1 as a computer workstation 116. Preferably, the user device, e.g., workstation 116, is communicatively coupled to the computer network 102 via a suitable communications link 118. It will be appreciated by those skilled in the art that the workstation 116 is depicted in FIG. 1 as a computer workstation for illustration purposes only. As the skilled artisan will understand, the workstation 116 shown in FIG. 1 is representative of any personal computing device known in the art, including, for example and without limitation, a laptop computer, a personal computer, a personal data assistant, a web-enabled cellular telephone, a smart phone, or other web-enabled electronic device suitably capable of generating and/or transmitting electronic document data to a multifunctional peripheral device. In the preferred embodiment, the workstation 116 is suitably adapted to generate document processing requests to the document processing device 104, as will be explained in greater detail below. Preferably, workstation 116 includes hardware, software, or any suitable combination thereof, capable of allowing an associated user to request a certificate, as well as request the performance of document processing operations. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Turning now to FIG. 2, illustrated is a representative architecture of a suitable controller 200, represented in FIG. 1 as the controller 106, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

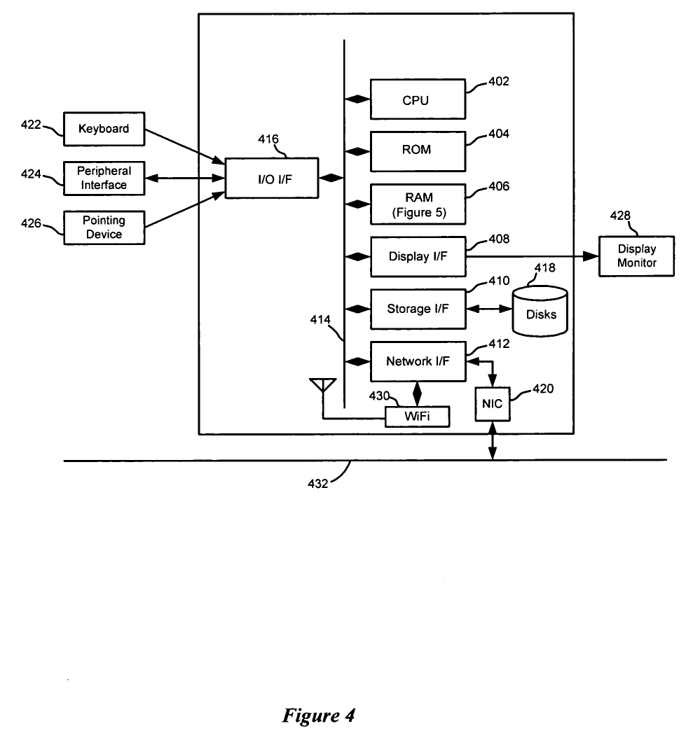

Turning now to FIG. 4, illustrated is a hardware diagram of a suitable workstation 400, shown in FIG. 1 as the workstation 116, for use in connection with the subject system 100. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

Read only memory 404 suitably includes firmware, such as static data or fixed instructions, such as BIOS, system functions, configuration data, and other routines used for operation of the workstation 400 via CPU 402.

Random access memory 406 provides a storage area for data and instructions associated with applications and data handling accomplished by processor 402.

Display interface 408 receives data or instructions from other components on bus 414, which data is specific to generating a display to facilitate a user interface. Display interface 408 suitably provides output to a display terminal 426, suitably a video display device such as a monitor, LCD, plasma, or any other suitable visual output device as will be appreciated by one of ordinary skill in the art.

Storage interface 410 suitably provides a mechanism for non-volatile, bulk or long term storage of data or instructions in the workstation 400. Storage interface 410 suitably uses a storage mechanism, such as storage 418, suitably comprised of a disk, tape, CD, DVD, or other relatively higher capacity addressable or serial storage medium.

Network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with bus 414 is suitably connected with an input device 422, such as a keyboard or the like. Input/output interface 416 also suitably provides data output to a peripheral interface 424, such as a USB, universal serial bus output, SCSI, Firewire (IEEE 1394) output, or any other interface as may be appropriate for a selected application. Finally, input/output interface 416 is suitably in data communication with a pointing device interface 428 for connection with devices, such as a mouse, light pen, touch screen, or the like.

In operation, a user desiring to make use of the document processing operations provided by the document processing device 104 must first procure a certificate from an administrator. The user, preferably via the workstation 116, sends a request for a certificate to a system administrator, i.e., the administrator device 112. In accordance with one embodiment of the subject application, the certificate request includes payment data representing a payment for services to be performed by the document processing device 104. When the administrator device 112 receives the certificate request from the user associated with the workstation 116, the target document processing device 104 is first identified. This identification is preferably accomplished by identifying the network address, such as the uniform resource locator or URL, of the desired document processing device 104. An allowable set of functions is then determined by the administrator device 112 corresponding to the user. As will be understood by those skilled in the art, the set of allowable functions, as contemplated herein, includes, for example and without limitation, a maximum number of document processing jobs allowed, a maximum number of pages allowed, color output, media, paper type, storage, and finishing options. In accordance with one embodiment of the subject application, the set of allowable functions is determined based upon the role assigned to the user, a payment made by the user, or the like. For example, the set of allowable functions is capable of being restricted to facsimile or copy operations based upon the amount of payment made by the user to the administrator 112. The set of allowable functions is then incorporated into constraint data. The administrator device 112 then generates a certificate including the constraint data and transmits the certificate to the document processing device 104. The document processing device 104 functions as a certificate authority and along with authorizing the certificate, stores constraint data in the local storage device 108. The certificate is then issued to the requesting workstation 116.

Once the user has a valid certificate, the user is able to proceed with requesting document processing operations. The workstation 116 then generates a document processing request, which is transmitted via the computer network 102 to the document processing device 104. The document processing device 104 receives the document processing request and prompts the workstation 116 for its certificate. Upon receipt of the user certificate, the controller 106 associated with the document processing device 104 compares the requested document processing operation to the constraint data associated with the received certificate. The controller 106 associated with the document processing device 104 then determines whether the request falls within the allowed set of functions, as set forth by the constraint data. When the request exceeds the limits of the constraint data, the controller 106 associated with the document processing device 104 notifies the user via the requesting workstation 116 of the incompatibility and denies the requested operation.

When the requested operation meets the limitations set forth by the constraint data, the document processing device 104 performs the selected operation. The constraint data associated with the certificate is then updated by the controller 106 associated with the document processing device 104. The skilled artisan will appreciate that updating the constraint data includes, for example, lowering the maximum number of pages allowed by the number processed in the current request, lowering the maximum number of jobs by the number of jobs processed in the current request, and the like. A notification is then generated by the controller 106, reflecting the performance of the requested document processing operation and sent to the requesting workstation 116. It will be understood by those skilled in the art that the notification transmitted to the workstation 116 is capable of including, for example, an updated certificate, replacing the certificate stored by the workstation 116, update data that updates the certificate on the workstation 116, or the like.

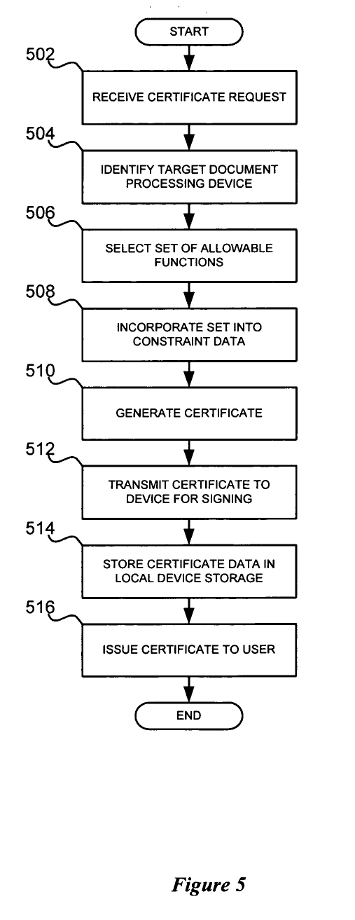

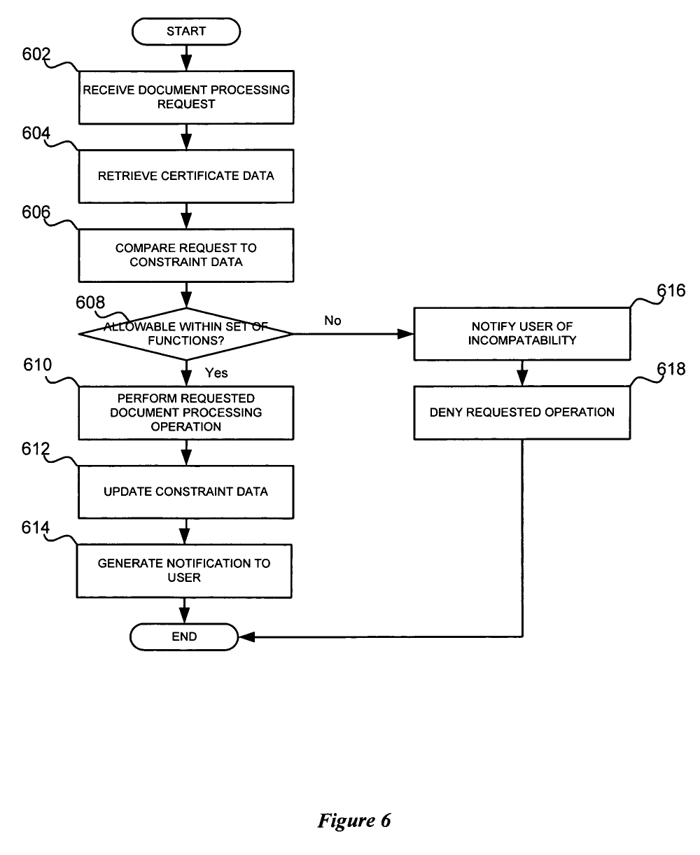

The foregoing system 100 and components illustrated in FIG. 1, FIG. 2, FIG. 3, and FIG. 4 will better be understood when viewed in conjunction with the methodologies shown in FIGS. 5 and 6. Turning now to FIG. 5, there is shown a flowchart 500 illustrating the method for certificate-based document processing for the certificate generation side in accordance with the subject application. Beginning at step 502, a certificate request is received from a user. The skilled artisan will appreciate that a system administrator, preferably associated with the administrator device 112, receives a certificate request from a user, such as a user associated with the workstation 116. In accordance with one embodiment of the subject application, the certificate request includes payment data representing a payment for services to be performed by the document processing device 104. At step 504, the administrator device 112 identifies the target document processing device 104. It will be appreciated by those skilled in the art that the document processing device selected by the user is identified by a network address, a uniform resource locator or URL link, or the like. It will further be appreciated by the skilled artisan that the designation or selection of the target document processing device 104 is capable of being limited by the administrator to a single device, limited to a narrow selection, or limited to one of a plurality of networked document processing devices.

Irrespective of the pool from which the target document processing device 104 is selected, flow proceeds to step 506, whereupon the administrator selects the set of allowable functions to be associated with the new certificate. As will be appreciated by those skilled in the art, the set of allowable functions, as contemplated herein, includes, for example and without limitation, a maximum number of document processing jobs allowed, a maximum number of pages allowed, color output, media, paper type, storage, and finishing options. In accordance with one embodiment of the subject application, the determination of the allowable set of functions is based upon the amount of payment received by the administrator from the user, i.e., the number of pages purchased, the number of jobs purchased, the colors, media, etc., that have been paid for, or the like. The determined set of allowable functions is then incorporated into constraint data at step 508. The administrator, via the administrator device 112, then generates a certificate, including the constraint data, at step 510.

The administrator device 112 then transmits the certificate to the target document processing device 104 at step 512 for signing. It will be appreciated by those skilled in the art that the document processing device 104 advantageously functions as a simple certificate authority, as is known in the art. The certificate data, which the document processing device 104 has signed, is then stored in the local storage device 108 and returned to the administrator device 112 at step 514. The administrator device 112 then issues the signed certificate to the requesting user at step 516. Preferably, the workstation 116 receives the signed certificate from the administrator device 112 via a secure communications channel and stores the certificate in a local storage location. It will be understood by those skilled in the art the use of the device 104 for signing is for example purposes only, and any suitable device is capable of signing the certificate in accordance with the spirit of the subject application. The skilled artisan will further appreciate that while the document processing device 104 is referenced as a certificate authority, the subject application is capable of using any suitable electronic device to function in this capacity in accordance with the methodologies described herein.

Having thus described the issuance of the certificate to a user, discussion now ensues with respect to the use of the certificate in requesting document processing operations. Referring now to FIG. 6, there is shown a flowchart 600 illustrating the method for certificate-based document processing from the certificate usage side in accordance with the subject application. At step 602, the document processing device 104 receives a document processing request from the user, wherein the document processing request includes data representing a desired document processing operation, user information, job processing data, and the like. At step 604, the user certificate corresponding to the received document processing request is retrieved by the controller 106 associated with the document processing device 104. In accordance with one aspect of the subject application, the certificate is included in the document processing request. Preferably, the certificate is transmitted by the workstation 116 to the document processing device 104 via secure link, for example and without limitation, a link using transport layer security protocols, as are known in the art. It will be understood by those skilled in the art that the user is authenticated by the controller 106 associated with the document processing device 104 prior to proceeding with document processing operations using the data contained in the certificate against the data previously stored by the device 104, i.e. when the device 104 signed the certificate during issuance.

The controller 106 associated with the document processing device 104 then compares, at step 606, the constraint data contained in the received certificate to the requested document processing operation. A determination is then made at step 608 whether the requested document processing operation, inclusive of user-selected output options, falls within the set of allowable functions, as set forth by the constraint data. When the request is not within the set of allowable functions, flow proceeds to step 616, whereupon the user is notified of the incompatibility of the request and the certificate. The document processing request is then denied at step 618 and the operation terminates.

When the received document processing request is compatible with the set of allowable functions, flow proceeds to step 610, whereupon the document processing device 104 performs the selected document processing operation. The constraint data associated with the certificate is then updated to reflect the current document processing operation at step 612. It will be understood by those skilled in the art that updating the constraint data includes, for example, lowering the maximum number of pages allowed by the number processed in the current request, lowering the maximum number of jobs by the number of jobs processed in the current request, and the like. Flow then progresses to step 614, whereupon a notification to the user is generated by the document processing device 104 indicating the performance of the requested document processing operation. Preferably, the notification includes the updated constraint data, which is then used to update the certificate on the workstation 116. In accordance with one embodiment of the subject application, the notification includes a new certificate, incorporating the revised constraint data, which thereafter replaces the certificate resident on the workstation 116.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A certificate-based document processing authority system comprising:
receiving means adapted for receiving a certificate request from an associated user, which certificate request includes identification data representative of an identification of the associated user;
generator means adapted for generating a certificate in accordance with the received certificate request, which certificate includes constraint data representative of a set of allowable functions for the associated user for at least one associated document processing device;
output means adapted for communicating the certificate to a storage associated with the at least one associated document processing device;
means adapted for receiving a document processing request from the associated user for the at least one associated document processing device, which document processing request includes data corresponding to the certificate, the document processing request further including job request data representative of at least one desired document processing operation;
verification means adapted for comparing the received document processing request with the certificate to determine whether the at least one desired document processing operation corresponds to the set of allowable functions;
means adapted for communicating data representative of the certificate to the associated user;
means adapted for selectively commencing a document processing operation on the at least one associated document processing device in accordance with an output of the verification means; and
means adapted for generating a notice to the associated user regarding a commenced document processing operation.

2. The certificate-based document processing authority system of claim 1, wherein the set of allowable functions includes at least one of maximum number of pages, maximum number of jobs, color output, media, paper type, storage, and finishing options.

3. The certificate-based document processing authority system of claim 2, wherein the certificate request includes payment data, and wherein the system further comprises means adapted for generating the constraint data in accordance with the payment data.

4. The certificate-based document processing authority system of claim 3, wherein the certificate includes address data corresponding to a network address of the at least one associated document processing device.

5. The certificate-based document processing authority system of claim 4, wherein the receiving means, generator means, and the output means are associated with an administrator in data communication with the associated user via an associated network.

6. The certificate-based document processing authority system of claim 4, wherein the network address includes a URL of the associated document processing device, and wherein the associated document processing device includes a multi-function peripheral.

7. A certificate-based document processing authority method comprising the steps of:
receiving a certificate request from an associated user, which certificate request includes identification data representative of an identification of the associated user;
generating a certificate in accordance with the received certificate request, which certificate includes constraint data representative of a set of allowable functions for the associated user for at least one associated document processing device;
communicating the certificate to a storage associated with the at least one associated document processing device;
receiving a document processing request from the associated user for the at least one associated document processing device, which document processing request includes data corresponding to the certificate, the document processing request further including job request data representative of at least one desired document processing operation;
comparing the received document processing request with the certificate to determine whether the at least one desired document processing operation corresponds to the set of allowable functions;
communicating data representative of the certificate to the associated user;
selectively commencing a document processing operation on the at least one associated document processing device in accordance with an output of the comparing a received document processing request with the certificate; and
generating a notice to the associated user regarding a commenced document processing operation.

8. The certificate-based document processing authority method of claim 7, wherein the set of allowable functions includes at least one of maximum number of pages, maximum number of jobs, color output, media, paper type, storage, and finishing options.

9. The certificate-based document processing authority method of claim 8, wherein the certificate request includes payment data, and wherein the method further comprises the step of generating the constraint data in accordance with the payment data.

10. The certificate-based document processing authority method of claim 9, wherein the certificate includes address data corresponding to a network address of the at least one associated document processing device.

11. The certificate-based document processing authority method of claim 10, wherein the steps of receiving a certificate, generating a certificate, and communicating the certificate to storage is performed via an administrator in data communication with the associated user via an associated network.

12. The certificate-based document processing authority method of claim 10, wherein the network address includes a URL of the associated document processing device, and wherein the associated document processing device includes a multi-function peripheral.

13. A computer-implemented method for certificate-based document processing authority comprising the steps of:
receiving a certificate request from an associated user, which certificate request includes identification data representative of an identification of the associated user;
generating a certificate in accordance with the received certificate request, which certificate includes constraint data representative of a set of allowable functions for the associated user for at least one associated document processing device;
communicating the certificate to a storage associated with the at least one associated document processing device;
receiving a document processing request from the associated user for the at least one associated document processing device, which document processing request includes data corresponding to the certificate, the document processing request further including job request data representative of at least one desired document processing operation;
comparing the received document processing request with the certificate to determine whether the at least one desired document processing operation corresponds to the set of allowable functions;
communicating data representative of the certificate to the associated user;
selectively commencing a document processing operation on the at least one associated document processing device in accordance with an output of the comparing a received document processing request with the certificate; and
generating a notice to the associated user regarding a commenced document processing operation.

14. The computer-implemented method for certificate-based document processing authority of claim 13, wherein the set of allowable functions includes at least one of maximum number of pages, maximum number of jobs, color output, media, paper type, storage, and finishing options.

15. The computer-implemented method for certificate-based document processing authority of claim 14, wherein the certificate request includes payment data, and wherein the method further comprises the step of generating the constraint data in accordance with the payment data.

16. The computer-implemented method for certificate-based document processing authority of claim 15, wherein the certificate includes address data corresponding to a network address of the at least one associated document processing device.

17. The computer-implemented method for certificate-based document processing authority of claim 16, wherein the steps of receiving a certificate, generating a certificate, and communicating the certificate to storage is performed via an administrator in data communication with the associated user via an associated network.

18. The computer-implemented method for certificate-based document processing authority of claim 16, wherein the network address includes a URL of the associated document processing device, and wherein the associated document processing device includes a multi-function peripheral.
